(19) United States
(12) Patent Application Publication
(10) Pub. No.: US 2026/0337449 A1
(43) Pub. Date: Oct. 29, 2026

(54) SILICONE COATING COMPOSITION

(71) Applicant: Dow Silicones Corporation, Midland, MI (US)

(72) Inventors: Yanhu Wei, Midland, MI (US); Peng-Fei Fu, Midland, MI (US); Joseph Sootsman, Saginaw, MI (US)

(21) Appl. No.: 19/108,773

(22) PCT Filed: Sep. 20, 2023
(86) PCT No.: PCT/US2023/074660

§ 371 Date: Mar. 5, 2025

Related U.S. Application Data
(60) Provisional application No. 63/408,331, filed on Sep. 20, 2022.

(51) Int. Cl. C09D 183/06; C09D 7/20

(52) U.S. Cl. CPC C09D 183/06; C09D 7/20

(57) ABSTRACT

The present invention relates to a composition comprising a T^{Ph} resin and a T^{Ph}_{-poly(phenylmethylsiloxane)} copolymer. The composition is useful as a coating for metal substrates, wherein the coating has excellent clarity, adhesion, resistance to cracking, and preservation of dielectric properties.

### BACKGROUND OF THE INVENTION

The present invention relates to a silicone coating composition, more particularly a composition that is resistant to cracking and dielectric degradation at high temperatures, and a method for preparing the composition. High temperature protective coatings and insulating materials to protect a variety of equipment and devices against extremely high temperatures. Heater elements for electric vehicles, exhaust systems for automotive engines, power plants, and top coatings for stoves, for example, all benefit from such protective coatings. In many applications, the coating layers must withstand temperatures exceeding 300° C. over several months without cracking or losing dielectric and insulating properties and must pass aggressive thermal shock tests over a broad temperature range.

High temperature resistance of silicones ostensibly makes them promising candidates as high temperature protective coatings and sealants; nevertheless, silicone rubbers are not resistant to cracking above 250° C. beyond 2 weeks. The combination of silicone and inorganic filler such as SiO₂, TiO₂, and Al₂O₃ provides a composition with long term high temperature resistance; however, coatings prepared from such compositions require aging at temperatures exceeding 500° C. to form ceramic-like coatings. At such extreme temperatures, the coatings are likely to crack and suffer thermal shock failure; moreover, electronic elements beneath the surface of the coating are vulnerable to damage. It would therefore be an advance in the field of high temperature protective coatings to develop a composition that provides a coating that is resistant to cracking, delamination, and thermal shock failure, while maintaining acceptable dielectric properties at temperatures exceeding 300° C. for an extended period.

### SUMMARY OF THE INVENTION

The present invention addresses a need in the art by providing a composition comprising a T^{Ph} resin, a T^{Ph}-poly(phenylmethylsiloxane) copolymer, and a substantial absence of ZO-poly(phenylmethylsiloxane)-OZ, where each Z is independently H, C₁-C₄-alkyl, or C(O)CH₃, wherein the w/w ratio of the T^{Ph} resin to the copolymer of the T^{Ph} resin and the poly(phenylmethylsiloxane) is in the range of from 15:85 to 35:65, wherein the resin and the copolymer comprise Si—OZ groups at a mol % concentration in the range of from 7.5 mol % to 12.0 mol %. The composition of the present invention is useful as a coating for a metal substrate, wherein the coating exhibits clarity, adhesion, and crack-resistance when subjected to high temperatures for hundreds of hours.

### BRIEF DESCRIPTION OF DRAWINGS

FIG. 1 is a series of three ²⁹Si NMR spectra of the composition of the present invention and two comparative compositions.

### DETAILED DESCRIPTION OF THE INVENTION

The present invention is a composition comprising a T^{Ph} resin, a T^{Ph}-poly(phenylmethylsiloxane) copolymer, and a substantial absence of ZO-poly(phenylmethylsiloxane)-OZ, where each Z is independently H, C₁-C₄-alkyl, or C(O)CH₃, wherein the w/w ratio of the T^{Ph} resin to the copolymer of the T^{Ph} resin and the poly(phenylmethylsiloxane) is in the range of from 15:85 to 35:65, wherein the resin and the copolymer comprise Si—OZ groups at a mol % concentration in the range of from 7.5 mol % to 12.0 mol %.

The term T^{Ph} resin refers to a crosslinked polymer having repeat units of phenyl-SiO_{3/2}, phenyl-SiO_{2/2} (OZ), and optionally phenyl-SiO_{1/2}(OZ)₂, where a unit of phenyl-SiO_{3/2} is represented by the following structure:

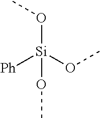

phenyl-SiO_{3/2};
where the dotted lines represent the point of attachment to another silicon atom; a unit of phenyl-SiO_{2/2}(OZ) is represented by the following structure:

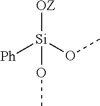

phenyl-SiO_{2/2}(OZ)
where Z is H, C₁-C₄-alkyl, or C(O)CH₃; and a unit of phenyl-SiO_{1/2}(OZ)₂ is represented by the following structure:

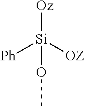

phenyl-SiO_{1/2}(OZ)₂

Each Z in the T^{Ph} resin is preferably H. Commercially available T^{Ph} resins include DOWSIL™ RSN-0217 and 0220 Flake Resins (A Trademark of The Dow Chemical Company or its Affiliates.)

The copolymer of the T^{Ph} resin and a poly(phenylmethylsiloxane) (T^{Ph}-PPhMS copolymer) contains repeat units of PPhMS:

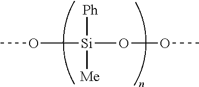

repeat units of PPhMS
where Z is as previously defined and n is preferably from 20 or from 40 or from 70 or from 100, to 300 or to 250 or to 200.

The composition can be prepared by first mixing in a suitable solvent and under reaction conditions a silanol-terminated PPhMS and a crosslinking agent, which is preferably an acetoxylating or alkoxylating agent. Examples of suitable acetoxylating agents include alkyltriacetoxysilanes such as methyltriacetoxysilane and ethyltriacetoxysilane; suitable alkoxylating agents include phenyltrimethoxysilane, phenyltriethoxysilane, methyltrimethoxysilane, ethyltrimethoxysilane, methyltriethoxysilane, and ethyltriethoxysilane. A commercial example of an acetoxylating agent is XIAMETER™ OSF-1579 Silane (A Trademark of The Dow Chemical Company and its Affiliates), which is a 50:50 w/w blend of methyltriacetoxysilane and ethyltriacetoxysilane. Suitable solvents include polar aprotic solvents such as ethyl acetate, propyl acetate, and butyl acetate.

The acetoxy or alkoxy terminated PPhMS is then advantageously contacted with the T^{Ph} resin at an advanced temperature to partially convert the T^{Ph} resin to a T^{Ph}-PPhMS copolymer, and to completely consume or nearly completely consume the acetoxy or alkoxy terminated PPhMS. Volatiles can be removed from the mixture to form a blend of copolymer and free T^{Ph} that can be used without further purification.

The finally formed composition comprises a substantial absence of ZO—PPhMS—OZ. As used herein, “a substantial absence of ZO—PPhMS—OZ” means that the composition comprises less than 10 weight percent, preferably less than 5 weight percent, more preferably less than 1 weight percent, and most preferably less than 0.5 weight percent of ZO—PPhMS—OZ, based on the weight of the T^{Ph} resin, the T^{Ph}-PPhMS copolymer, and the ZO—PPhMS—OZ.

Alternatively, the blend of T^{Ph} resin and T^{Ph}-PPHMS copolymer can be prepared by totally converting the T^{Ph} resin to the T^{Ph}-PPhMS copolymer, then adding sufficient T^{Ph} to the copolymer to form the desired blend of copolymer and free T^{Ph}.

It has been surprisingly discovered that a blend of T^{Ph} resin and T^{Ph}-PPhMS copolymer is critical to achieve the combination of clarity, resistance to cracking, and adhesion to the substrate of the film prepared from the composition. Preferably, the w/w ratio of T^{Ph} resin to T^{Ph}-PPhMS copolymer in the composition is in the range of from 15:85 or from 20:80 or from 24:76, to 35:65 or to 30:70 to 28:72.

Though not bound by theory, it is believed that the T^{Ph}-PPhMS copolymer creates a clear haze-free coating through the compatibilization of otherwise incompatible materials (T^{Ph} and ZO—PPhMS—OZ); moreover, the presence of a critical concentration of unreacted Si—OH groups in the residual T^{Ph} resin provides the adherence of the coating to the substrate through hydrogen bonding of the Si—OH groups, but lacking in sufficiency in the T^{Ph}-PPhMS copolymer alone.

The mol % concentration of Si—OZ groups in the blend of T^{Ph} resin and T^{Ph}-PPHMS copolymer is in the range of from 7.5 or from 9.0 or from 10.5 or from 11.0 mole %, to 12 or to 11.5 mol %. As used herein, the term mole % concentration of Si—OZ groups refers to the ratio of the area measured for the resonances associated with Si—OZ groups to the total area of resonances in the ²⁹Si spectrum of a sample of the composition.

Preferably, the T^{Ph} resin and the T^{Ph}-PPhMS copolymer comprise at least 90 or at least 95 or at least 99 weight percent or at least 99.5 weight percent of the composition, based on the weight of the T^{Ph} resin, the T^{Ph}-PPhMS copolymer, and ZO—PPhMS—OZ, as determined by ²⁹Si NMR spectroscopy. Alternatively, the composition comprises less than 5 or less than 1 or less than 0.5 weight percent of OZ—PPhMS—OZ.

In another aspect, the present invention is a method comprising the step of contacting under coupling conditions a terminally alkoxylated or acetylated PPhMS with T^{Ph} resin for a sufficient time to reduce the total mole % of Si—OZ groups in the T^{Ph} resin, preferably Si—OH groups, by 10 mole % or by 15 mole %, to 30 mole % or to 25 mole %, as measured by the reduction in the area under the resonances between −65 ppm and −75 ppm of the ²⁹Si NMR spectrum compared with that of the initial T^{Ph} in the mixture. More particularly, the method comprises the step of contacting a T^{Ph} resin with ZO—PPhMS—OZ in the presence of a polar aprotic solvent at a temperature in the range of from 77° C. or from 100° C., to 200° C. or to 150° C., for a time in the range of from 15 minutes or from 30 minutes to 10 hours or to 5 hours or to 2 hours; and preferably with concomitant distillation and removal of the solvent. The method provides a simple and efficient way of preparing the coating composition.

### EXAMPLES

### Nuclear Magnetic Resonance Spectroscopy (NMR) Measurements

Nuclear magnetic resonance (NMR) spectra were obtained on a Varian EX-400 5 MHz Mercury spectrometer with C₆D₆ or CDCl₃ solvent. Chemical shifts for ²⁹Si-NMR spectra were referenced to the resonance of the internal solvent and reported relative to tetramethylsilane.

### Comparative Example 1—Preparation of a Blend of a T^{Ph} Resin and Hydroxyl Terminated PPhMS

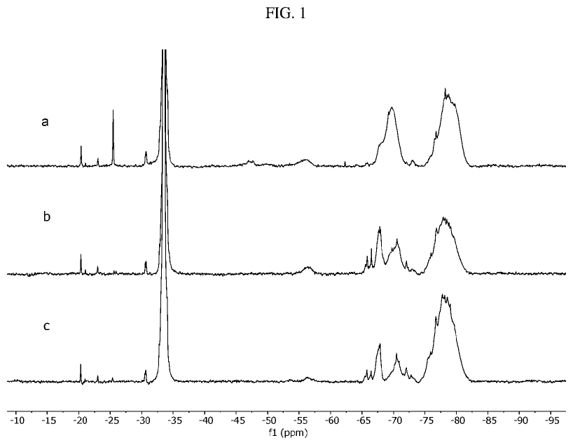

A physical blend of hydroxyl terminated PPhMS with a degree of polymerization of 139 (65 g) and DOWSIL™ RSN-0217 Flake Resin (T^{Ph} resin, 35 g) was prepared. The mole % of Si—OH groups was measured by ²⁹Si NMR spectroscopy to be 12.7 mole %, as determined by dividing the area under the resonances in the range of from −65 ppm to −75 ppm over the areas of all resonances appearing in the spectrum (FIG. 1a).

### Example 1—Preparation of a Partially Coupled T^{Ph} Resin and a T^{Ph}-PPhMS Copolymer

Hydroxyl terminated PPhMS with a degree of polymerization of 139 (65 g), XIAMETER™ OSF-1579 Silane (5 g), and butyl acetate (50 g) were added to a 500-mL 3-necked dry flask fitted with a Dean-Stark trap. The mixture was stirred at 50° C. under N₂ for 30 min, after which time DOWSIL™ RSN-0217 Flake Resin (T^{Ph} resin, 35 g) and butyl acetate (60 g) were added to the reaction mixture. The mixture was heated to reflux for 1 h, during which time volatiles (~60 g) were gradually removed and collected in the Dean-Stark trap. The contents of the flask were allowed to cool to room temperature and were used as a coating composition without filtration or further purification. Gel permeation chromatography of the product demonstrated incomplete conversion of the T^{Ph} resin and an upward shifting of molecular weight of the peaks associated with the PPhMS. ²⁹Si NMR spectroscopy of the partially coupled composition (FIG. 1b) demonstrated the complete (or near complete) absence of a resonance at −25 ppm associated with acetoxylated PPhMS groups (FIG. 1a), which gives strong evidence of the complete conversion of the acetoxylated PPhMS to the T^{Ph}-PPhMS copolymer. The mole % of Si—OZ groups was measured by ²⁹Si NMR spectroscopy to be 11.3 mole %. The weight % of residual T^{Ph} resin was found to be 26.5% by gel permeation chromatography.

### Comparative Example 2—Preparation of Extensively Coupled T^{pH} Resin and a T^{Ph}-PPhMS

The procedure of Example 1 was repeated, except that the contents of the vessel were heated to reflux for 36 h after addition of the T^{Ph} resin. After removal of volatiles, the composition had a solids content of about 67 wt %. The reaction solution was cooled down and directly used as coating composition without filtration and further purification. The mole % of Si—OZ groups was measured by ²⁹Si NMR spectroscopy to be 6.6 mole % (FIG. 1c).

### Gel Permeation Chromatography (GPC) Method

Gel permeation chromatography (GPC) analysis was carried out using an Agilent 1260 Infinity II chromatograph equipped with a triple detector composed of a differential refractometer, an online differential viscometer, a low angle light scattering (LALS: 15° and 90° angles of detection), and a column (2 PL Gel Mixed C, Varian). Toluene (HPLC grade, Biosolve) was used as mobile phase at a flow rate of 1 mL/min.

### Cracking Time Measurement

The cured coatings were aged at 300° C. Cracking was checked every other day for the first 14 days, then once per week thereafter. The cracking time was recorded when cracks were observed in the coatings.

### Dielectric Resistance Measurement

The aged coatings were kept in an 85% humidity room for 24 h, then set between electrodes to measure the current resistance with a multimeter. If the measured resistance was found to be lower than 1000 ohms, the aged coating was deemed a failure for dielectric resistance.

### Thermal Cycle Test:

Each formulation was coated as a 100-μm film, followed by curing at ambient temperature or 150° C., then aged at 300° C. for 10 d, after which time 100 cycles of a thermal cycle test (between −50° C. and 150° C.) was performed for each aged sample by using a Tenney Thermal Chamber. The aged samples were put in the chamber, followed by running the test between −50° C. and 150° C. (temperature ramping rate 20° C./min, 10 min per cycle). The coating samples were deemed to pass the thermal cycle test if no cracks and no delamination were observed on the films during 100 cycles of test.

### Thermal Stability Testing

The compositions were tested for thermal stability. Each sample (70 parts by weight) was dissolved in butyl acetate (30 parts by weight) and coated 50-μm films on an Alumina panel for cracking and adhesion tests. The film cracking time (synonymous with dielectric failure) was recorded for each sample during the 300° C. aging. The % adhesion was measured according to ASTM method D3359 by using a Gardco PA-2000 adhesion test kit after 240 h aging at 300° C. In Table 1, % Adhesion refers to the percent of adhesion that remained after thermal aging. The higher the percent, the stronger the adhesion of the materials to substrates. The coating clarity, cracking time, and adhesion were recorded for each coating.

TABLE 1
Thermal Stability Testing Results

| | Coating | Cracking | % |
|---|---|---|---|
| Example | Clarity | Time | Adhesion |
| Ex 1 | Clear | 888 h | 100 |
| Comp. 1 | Hazy | 480 h | 100 |
| Comp. 2 | Clear | 408 h | 60 |

The data show that the composition of the present invention exhibited superior clarity, cracking time, and adhesion properties compared to either the blend of the resin and the OZ-terminated PPhMS or the more extensively coupled T^{Ph} resin and the T^{Ph}-PPhMS copolymer. The example composition also had a measured resistance of >1000 ohms, confirming the preservation of dielectric properties.

1. A composition comprising a T^{Ph} resin, a T^{Ph}-poly(phenylmethylsiloxane) copolymer, and a substantial absence of ZO-poly(phenylmethylsiloxane)-OZ, where each Z is independently H, C₁-C₄-alkyl, or C(O)CH₃, wherein the w/w ratio of the T^{Ph} resin to the copolymer of the T^{Ph} resin and the poly(phenylmethylsiloxane) is in the range of from 15:85 to 35:65, wherein the resin and the copolymer comprise Si—OZ groups at a mol % concentration in the range of from 7.5 mol % to 12.0 mol %.

2. The composition of claim 1 wherein the w/w ratio of the T^{Ph} resin to the T^{Ph}-poly(phenylmethylsiloxane) copolymer is in the range of from 20:80 to 30:70; wherein the composition comprises less than 5 weight percent of ZO-poly(phenylmethylsiloxane)-OZ; wherein the resin and the copolymer comprise Si—OZ groups at a mol % concentration in the range of from 9.0 mol % to 12.0 mol %; and wherein the poly(phenylmethylsiloxane) has a degree of polymerization in the range of from 20 to 300.

3. The composition of claim 1 wherein the w/w ratio of the T^{Ph} resin to the T^{Ph}-poly(phenylmethylsiloxane) copolymer is in the range of from 24:76 to 30:70; wherein the composition comprises less than 1 weight percent of ZO-poly(phenylmethylsiloxane)-OZ; wherein the resin and the copolymer comprise Si—OZ groups at a mol % concentration in the range of from 10.5 mol % to 11.5 mol %; where Z is H or C(O)CH₃; and wherein the poly(phenylmethylsiloxane) has a degree of polymerization in the range of from 40 to 250.

4. The composition of claim 1 wherein the poly(phenylmethylsiloxane) has a degree of polymerization in the range of from 100 to 200.

5. A method comprising the step of contacting under coupling conditions ZO-poly(phenylmethylsiloxane)-OZ with a T^{Ph} resin for a sufficient time to reduce the total mole % of Si—OZ groups in the T^{Ph} resin by 10 mole % to 30 mole %; where each Z is independently H, C₁-C₄-alkyl, or C(O)CH₃.

6. The method of claim 5 wherein the ZO-poly(phenylmethylsiloxane)-OZ is contacted with the T^{Ph} resin in the presence of a polar protic solvent at a temperature in the range of from 77° C. to 150° C. for reaction a time in the range of from 15 minutes to 10 hours.

7. The method of claim 6 wherein the solvent is ethyl acetate, propyl acetate, or butyl acetate, and the reaction time is in the range of from 30 minutes to 2 hours; wherein the method further comprises the step of distillation and removal the solvent.

8. The method of claim 7 wherein the solvent is butyl acetate.
